(19) United States
(12) Patent Application Publication
(10) Pub. No.: US 2007/0164936 A1
(43) Pub. Date: Jul. 19, 2007

(54) ORGANIC LIGHT-EMITTING DISPLAY AND DRIVING DEVICE THEREOF

(75) Inventor: Hung-Jung Chang, Hsinchu (TW)

Correspondence Address: J C PATENTS, INC., 4 VENTURE, SUITE 250, IRVINE, CA, 92618, US

(73) Assignee: RITDISPLAY CORPORATION, Hsinchu (TW)

(21) Appl. No.: 11/468,580

(22) Filed: Aug. 30, 2006

(30) Foreign Application Priority Data
Jan. 13, 2006 (TW) 95101414

(51) Int. Cl. G09G 3/30

(52) U.S. Cl. 345/76

(57) ABSTRACT

A driving device for an organic light-emitting panel is provided. The driving device includes a data-driving unit, a first scan-driving unit and a second scan-driving unit. The organic light-emitting panel includes a plurality of data lines and a plurality of scan lines. Each scan line has two ends connected to the driving device. Furthermore, the first scan-driving unit includes a plurality of first switches and the second scan-driving unit includes a plurality of second switches. The first switch connected to one end of one of the scan lines and the second switch connected to the other end of the same one of the scan lines are selectively simultaneously connected to a reference voltage or a ground voltage.

### BACKGROUND OF THE INVENTION

1. Field of the Invention

The present invention relates to an organic light-emitting display. More particularly, the present invention relates to a driving device that can increase the uniformity of the brightness of an organic light-emitting display.

2. Description of Related Art

FIG. 1 is a circuit diagram of a conventional organic light-emitting display. As shown in FIG. 1, the organic light-emitting display 100 includes a data-driving circuit 110, a scan-driving circuit 120, a plurality of data lines X1˜Xm, a plurality f scan lines Y1˜Yn, a plurality of parasitic resistors R11˜Rnm and a plurality of light-emitting diodes D11˜Dnm. Here, all the parasitic resistors R11˜Rnm are assumed to have an identical resistance and the resistance is assumed to be R. Furthermore, all the light-emitting diodes D11˜Dnm are assumed to have an identical specification. In addition, the data-driving circuit 110 has a plurality of switches SWX1˜SWXm, and the scan-driving circuit 120 has a plurality of switches SWY1˜SWYn. The switches SWX1˜SWXm permit each of the corresponding data lines X1˜Xm to couple with one of the corresponding constant current source CS1˜CSm or a ground voltage GND. Similarly, the switches SWY1˜SWYn permit each of the corresponding scan lines Y1˜Yn to couple with the voltage source Vcc or the ground voltage GND.

To display some pictures, the scan lines Y1˜Yn of the organic light-emitting display 100 are sequentially enabled. When it is time to activate the scan line Y3, only the switch SWY3 among the switches SWY1˜SWYm is coupled to the ground voltage GND. All the other switches SWY1, SWY2, SWY4˜SWYm are coupled to the voltage source Vcc. Because of the passing of a current through the light-emitting diodes D31˜D3m, the diodes are illuminated. The voltages V1˜Vm on the scan line Y3 are respectively:

V1=I×R×m

V2=V1+I×R×(m−1)

V3=V2+I×R×(m−2)

Vm=V(m−1)+I×R

In the above equations, I represents the current of various current sources CS1˜CSm. According to the equations, the voltage on the scan line Y3 increases toward the right side. In other words, the light-emitting diode D31 is the brightest while the other light-emitting diodes D32˜D3m further to the right are dimmer. Hence, a picture displayed using the organic light-emitting display 100 will have non-uniform brightness. Furthermore, because the current passing through the light-emitting diodes D31˜D3m flows toward the switch SWY3, the current flowing through the parasitic resistance on the left side of the organic light-emitting display 100 is larger so that power consumption is higher. As a result, the organic light-emitting display panel has a relatively low performance efficiency and display quality.

### SUMMARY OF THE INVENTION

Accordingly, at least one objective of the present invention is to provide a driving device for an organic light-emitting display panel such that the organic light-emitting display panel can have more uniform display brightness and lower power consumption for its internal parasitic resistors.

At least another objective of the present invention is to provide an organic light-emitting display comprising a driving device and an organic light-emitting display panel such that the organic light-emitting display panel has a more uniform display brightness and a lower power consumption for its internal parasitic resistors.

At least yet another objective of the present invention is to provide an organic light-emitting display panel having uniform display brightness and lower power consumption for its internal parasitic resistors.

To achieve these and other advantages and in accordance with the purpose of the invention, as embodied and broadly described herein, the invention provides an organic light-emitting display comprising an organic light-emitting display panel and a driving device. The organic light-emitting display panel includes a plurality of data lines, a plurality of scan lines and a plurality of light-emitting devices. Each scan line has two ends and the light-emitting devices are disposed at each junction between the data lines and the scan lines. Furthermore, the anode of each light-emitting device is coupled to a corresponding data line and the cathode of each light-emitting device is coupled to a corresponding scan line. Moreover, the light-emitting devices are arranged to form an array. The driving device includes a data-driving unit, a first scan-driving unit and a second scan-driving unit. The data-driving unit includes a plurality of select switches and a plurality of current sources. Each select switch is coupled to one end of a corresponding one of the data lines and is selectively coupled to one of the current sources or a ground voltage.

In addition, the first scan-driving unit includes a plurality of first switches. Each first switch is coupled to one end of a corresponding one of the scan lines and is selectively coupled to a reference voltage or a ground voltage. The second scan-driving unit includes a plurality of second switches. Each second switch is coupled to the other end of a corresponding one of the scan lines and is selectively coupled to the reference voltage or the ground voltage. The first switch coupled to one end of one of the scan lines and the second switch coupled to the other end of the same one of the scan lines are selectively simultaneously coupled to the reference voltage or the ground voltage.

In one embodiment of the present invention, the foregoing reference voltage is a source voltage and the foregoing light-emitting device is an organic light-emitting diode or a polymer light-emitting diode. Furthermore, the aforementioned current source can be designed as a constant current source. According to the desired display data, the current is provided for a length of time so that the brightness level of the light-emitting device can be precisely controlled. Alternatively, the aforementioned current source can be designed as a variable current source. According to the desired display data, the size of the current is varied so that the brightness level of the light-emitting device can be precisely controlled.

In brief, the organic light-emitting display in the present invention uses a design that includes coupling one end and the other end of each scan line of the organic light-emitting display panel to a first scan-driving unit and a second scan-driving unit respectively. Moreover, the first switch and the second switch that couples respectively with one end and the other end of each scan line are simultaneously connected to the reference voltage or the ground voltage. Thus, the distribution of current on the organic light-emitting display panel is more uniform so that the brightness of the panel is more uniform. In addition, it reduces the power consumption of the parasitic resistors as well.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional organic light-emitting display.

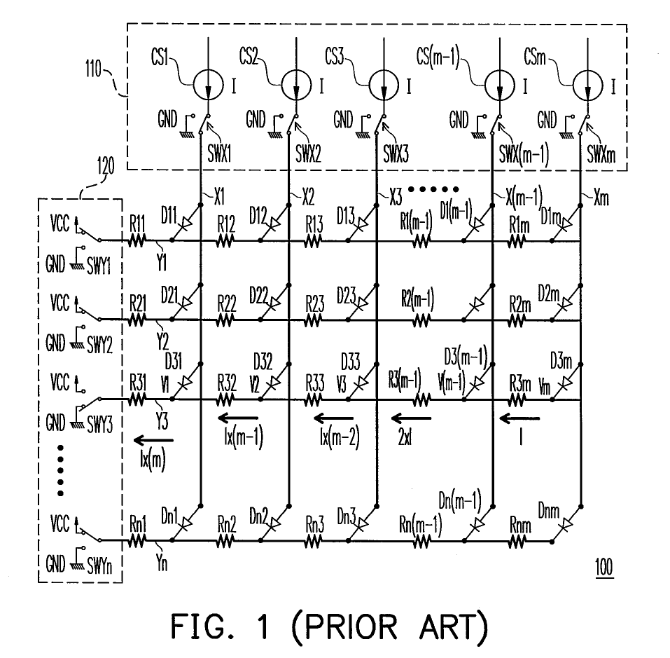

FIG. 2 is a diagram for an organic light-emitting display panel according to one embodiment of the present invention.

FIG. 3 is a circuit diagram of an organic light-emitting display according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

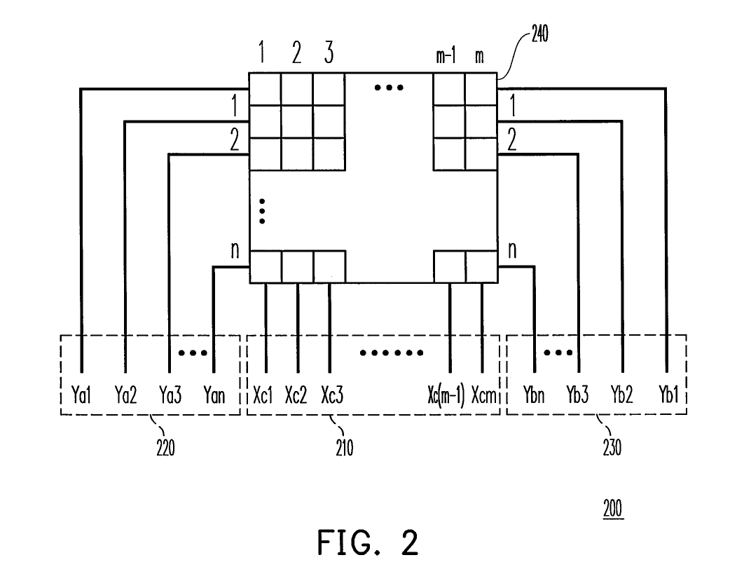

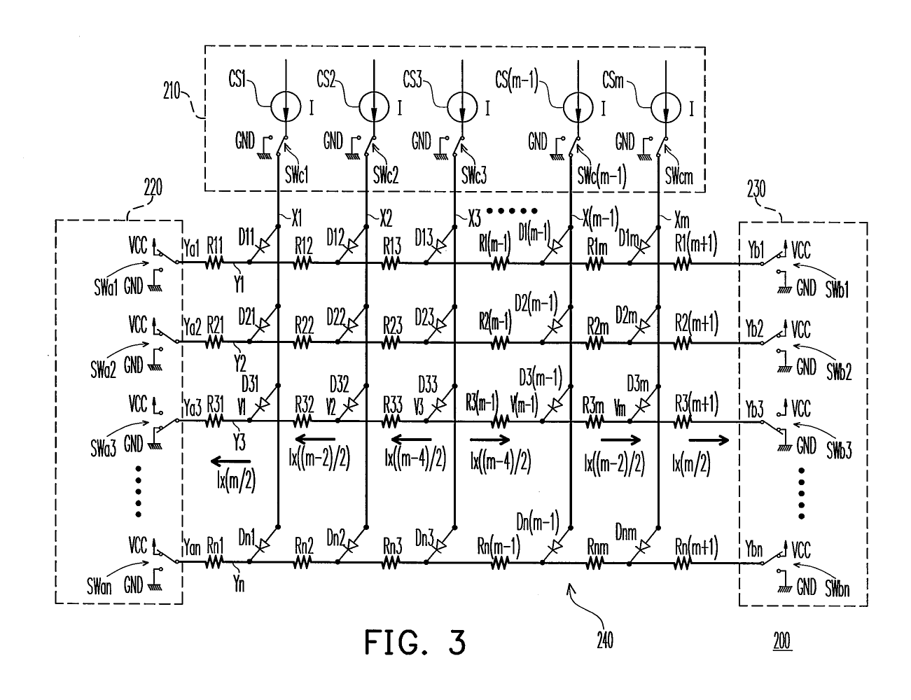

FIG. 2 is a diagram for an organic light-emitting display panel according to one embodiment of the present invention. FIG. 3 is a circuit diagram of an organic light-emitting display according to one embodiment of the present invention. As shown in FIG. 2, a driving device drives the organic light-emitting display panel 240 of the present invention. The driving device includes a data-driving unit 210, a first scan-driving unit 220 and a second scan-driving unit 230. The organic light-emitting display panel 240 has n×m pixels. In other words, the display panel 240 has n scan lines and m data lines. Each scan line has two ends. One end of the scan line is coupled to the first scan-driving unit 220 and the other end of the scan line is coupled to the second scan-driving unit 230.

More specifically, as shown in FIG. 3, the organic light-emitting display panel 240 includes a plurality of data lines X1˜Xm, a plurality of scan lines Y1˜Yn and a plurality of organic light-emitting diodes D11˜Dnm. Each scan line Y1˜Yn has two ends. Furthermore, each organic light-emitting diode D11˜Dnm is disposed at the junction between each data line X1˜Xm and each scan line Y1˜Yn. The anode of each organic light-emitting diode D11˜Dnm is coupled to one of the corresponding data lines X1˜Xm and the cathode of each organic light-emitting diode D11˜Dnm is coupled to one of the corresponding scan lines Y1˜Yn. For example, the anode of the light-emitting diode D32 is coupled to the data line X2 and the cathode of the light-emitting diode D32 is coupled to the scan line Y3. In addition, the organic light-emitting diode D11˜Dnm are arranged to from an array.

The data-driving unit 210 includes a plurality of select switches SWc1˜SWcm and a plurality of current sources CS1˜CSm. The select switches SWc1˜SWcm are coupled to one end of the corresponding data lines X1˜Xm. Furthermore, the select switches SWc1˜SWcm can be selectively coupled to one of the current sources CS1˜CSm or a ground voltage GND. In other words, the switch SWc1 can be selectively coupled to the current source CS1 or the ground voltage GND and the switch SWc2 can be selectively coupled to the current source CS2 or the ground voltage GND and so on.

In addition, the first scan-driving unit 220 includes a plurality of first switches SWa1˜SWan. Each first switch SWa1˜Swan is coupled to one end Ya1˜Yan of a corresponding scan line Y1˜Yn. In other words, the first switch SWa1 is coupled to one end Ya1 of the scan line Y1 and the second switch SWa2 is coupled to one end Ya2 of the scan line Y2 and so on. Moreover, each one of the first switches SWa1˜Swan can be selectively coupled to a source voltage Vcc or the ground voltage GND.

The second scan-driving unit 230 also includes a plurality of second switches SWb1˜SWbn. Each one of the second switches SWb1˜SWbn is coupled to another end Yb1˜Ybn of a corresponding scan line Y1˜Yn. In other words, the second switch SWb1 is coupled to one end Yb1 of the scan line Y1 and the second switch SWb2 is coupled to one end Yb2 of the scan line Y2 and so on. Furthermore, each one of the second switches SWb1˜SWbn can be selectively coupled to the source voltage Vcc or the ground voltage GND.

The first switch SWa1˜SWan and the second switch SWb1˜SWbn connected to one end Ya1˜Yan and the other end Yb1˜Ybn of the scan line Y1˜Yn can be simultaneously coupled to the source voltage Vcc or the ground voltage GND. For example, using the first switch SWa1 and the second switch SWb1 connected to the respective ends of the scan line Y1 as an example, when the first switch SWa1 is connected to the source voltage Vcc, the second switch SWb1 is also connected to the source voltage Vcc. Alternatively, when the first switch SWa1 is connected to the ground voltage GND, the second switch SWb1 is also connected to the ground voltage GND. In addition, the aforementioned organic light-emitting diode can also be a light-emitting device such as a polymer light-emitting diode.

When the organic light-emitting display 200 in the present embodiment is used to display images, the scan lines Y1˜Yn are sequentially enabled. Assume the scan line Y3 is enabled, that is, the first switch SWa3 at one end Ya3 and the second switch SWb3 at the other end Yb3 of the scan line Y3 are simultaneously coupled to the ground voltage GND, all the other first switches SWa1, SWa2, SWa4˜SWan and the second switches SWb1, SWb2, SWb4˜SWbn are coupled to the source voltage Vcc. Therefore, the size of the voltages V1˜Vm on the scan line Y3 are:

V1=I×R×(m/2)

V2=V1+I×R×[(m−2)/2]

V3=V2+I×R×[(m−4)/2]

V(m−1)=Vm+I×R×[(m−2)/2]

Vm=I×R×(m/2)

In the above equations, I represents the current of various current sources CS1˜CSm. According to the equations, the voltage on the scan line Y3 shows a left-right symmetry so that the voltage gets smaller toward the sides and gets larger toward the middle. Hence, the current in the organic light-emitting display panel 240 of the present invention is distributed in such a way that the current gets smaller toward the middle and larger toward the sides. Since such symmetrical current distribution is more symmetrical and uniform, the power consumption of the parasitic resistors R11˜Rn(m+1) is reduced. Moreover, the voltage drop of the organic light-emitting diode closer to the left and right side of the organic light-emitting display panel 240 is more than the voltage drop of the organic light-emitting diode closer to the middle of the organic light-emitting display panel 240. Therefore, the organic light-emitting diodes closer to the sides of the organic light-emitting display panel 240 has a higher but more uniform brightness level than the organic light-emitting diodes near the middle.

In summary, the organic light-emitting display in the present invention uses a design that includes coupling one end and the other end of each scan line of the organic light-emitting display panel to a first scan-driving unit and a second scan-driving unit respectively. Moreover, the first switch and the second switch that couples respectively with one end and the other end of each scan line are simultaneously connected to the reference voltage or the ground voltage. Thus, the distribution of current on the organic light-emitting display panel is more even so that the displayed brightness level is more uniform. In addition, there is a lowering of the power consumption of the parasitic resistors as well.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device for an organic light-emitting display panel, wherein the organic light-emitting display panel comprises a plurality of data lines and a plurality of scan lines with a light-emitting device disposed at each junction between the data lines and the scan lines, and each scan line has two ends coupled to the driving device, the driving device comprising:
a data-driving unit having a plurality of select switches and a plurality of current sources, wherein each select switch is coupled to one end of a corresponding one of the data lines and is selectively coupled to a corresponding one of the current sources or a ground voltage;
a first scan-driving unit having a plurality of first switches, wherein each first switch is coupled to one end of a corresponding one of the scan lines and is selectively coupled to a reference voltage or the ground voltage; and
a second scan-driving unit having a plurality of second switches, wherein each second switch is coupled to the other end of the corresponding one of the scan lines and is selectively coupled to the reference voltage or the ground voltage,
wherein the first switch coupled to one end of one of the scan lines and the second switch coupled to the other end of the same one of the scan line are selectively simultaneously coupled to the reference voltage or the ground voltage.

2. The driving device of claim 1, wherein the reference voltage comprises a source voltage.

3. The driving device of claim 1, wherein the light-emitting devices comprise organic light-emitting diodes or polymer light-emitting diodes.

4. The driving device of claim 1, wherein the current sources comprise constant current sources.

5. An organic light-emitting display, comprising:
an organic light-emitting display panel, having:
a plurality of data lines;
a plurality of scan lines, wherein each scan line has two ends; and
a plurality of light-emitting devices disposed at each junction between the data lines and the scan lines, wherein an anode of each light-emitting device is coupled to a corresponding one of the data lines and a cathode of each light-emitting device is coupled to a corresponding one of the scan lines, and the light-emitting devices are arranged to form an array; and
a driving device, comprising:
a data-driving unit having a plurality of select switches and a plurality of current sources, wherein each select switch is coupled to one end of a corresponding one of the data lines and is selectively coupled to a corresponding one of the current sources or a ground voltage;
a first scan-driving unit having a plurality of first switches, wherein each first switch is coupled to one end of a corresponding one of the scan lines and is selectively coupled to a reference voltage or the ground voltage; and
a second scan-driving unit having a plurality of second switches, wherein each second switch is coupled to the other end of the corresponding one of the scan lines and is selectively coupled to the reference voltage or the ground voltage,
wherein the first switch coupled to one end of one of the scan lines and the second switch coupled to the other end of the same one of the scan lines are selectively simultaneously coupled to the reference voltage or the ground voltage.

6. The organic light-emitting display of claim 5, wherein the reference voltage comprises a source voltage.

7. The organic light-emitting display of claim 5, wherein the light-emitting devices comprise organic light-emitting diodes or polymer light-emitting diodes.

8. The organic light-emitting display of claim 5, wherein the current sources comprise constant current sources.

9. An organic light-emitting display panel, comprising:
a plurality of data lines;
a plurality of scan lines, wherein each scan line has two ends; and
a plurality of light-emitting devices disposed at each junction between the data lines and the scan lines, wherein each light-emitting device has an anode coupled to a corresponding one of the data lines and a cathode coupled to a corresponding one of the scan lines, and the light-emitting devices are arranged to form an array.

10. The organic light-emitting display panel of claim 9, wherein the light-emitting devices comprise organic light-emitting diodes or polymer light-emitting diodes.
